(19) United States
(12) Patent Application Publication
(10) Pub. No.: US 2009/0123902 A1
(43) Pub. Date: May 14, 2009

(54) Method And System For The Preparation Of The General Education Development Test

(76) Inventors: Nancy N. Higgs, South Melbourne Beach, FL (US); Taylor Vaughan, Melbourne, FL (US); Sandra B. Davis, Signal Mountain, TN (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/189,250

(22) Filed: Aug. 11, 2008

Related U.S. Application Data
(60) Provisional application No. 60/955,318, filed on Aug. 10, 2007.

(51) Int. Cl. G09B 7/00

(52) U.S. Cl. 434/323; 434/322

(57) ABSTRACT

The present invention is directed to a method and system for individualizing preparation for a high school equivalency test. The method and system comprise obtaining from the individual an initial skills assessment in one or more subject areas of the high school equivalency test. The initial skills assessment provides a raw score in one of the subject areas. The method and system further comprise determining an Alpha score for the respective subject area based on the initial skills assessment. The Alpha score is a difference between a passing score for the high school equivalency test and the raw score from the initial skills assessment in the same subject area.

### REFERENCE TO RELATED APPLICATIONS

This application claims the benefit, under 35 U.S.C. 119(e), of the provisional patent application entitled PROCESS FOR THE PREPARATION AND ADMINISTRATION OF THE GENERAL EDUCATION DEVELOPMENT TEST, filed on Aug. 10, 2007, and assigned application No. 60/955,318.

### FIELD OF THE INVENTION

The present invention is related generally to methods for test preparation and specifically to methods for preparation for the General Education Development test.

### BACKGROUND OF THE INVENTION

Successful completion of the General Education Development (GED®) Tests developed and administered by the GED® Testing Service of the American Council on Education is equivalent to successful completion of secondary school (high school) and thus the test-taker is awarded the equivalent of a high school diploma. The GED® Tests were developed following World War II to give returning veterans, who joined the service without completing high school, a way to move forward with their education and careers without returning to high school. It since has been used by millions of adults as an alternative to completing a high school diploma and enables them to move forward with their educations and careers.

Currently, approximately one-third of high school students fail to graduate, which severely limits their educational and occupational options and costs them nearly $500,000 in lifetime earnings. Similarly, the cost to the nation is enormous in lost potential and additional support services.

Additionally, passing the GED® Tests is not easy. In fact, only about 62% of test-takers are successful nationwide. Current preparation methods include traditional adult basic education classes that have a completion rate of 27%, online self-directed and self-paced study, and other self-help-books and assessments.

### SUMMARY OF THE INVENTION

The present inventors have surprisingly found that a critical success factor for preparing an individual for a high school equivalency test is that the methodology used addresses the short-term focus of young adults and the need to see results quickly. Thus, the present invention has developed a method and system as described below for preparing for a high school equivalency test that specifically caters to the individual's short term focus and desire to see immediate results. Hereinafter, the specifications makes reference to the GED® Tests as it is the currently recognized high school equivalency test in the U.S. However it is understood that the present invention is not limited to the GED® Tests.

In accordance with one aspect of the present invention, there is provided a method for preparing an individual for a high school equivalency test. The method comprises obtaining from the individual an initial skills assessment in at least one subject area of the high school equivalency test. The method further comprises determining an Alpha score for at least one subject area based on the initial skills assessment, wherein the Alpha score is a difference between a passing score for the high school equivalency test in at least one subject area and the raw score in at least one subject area. In addition, the method comprises preparing a comprehensive prescription plan for at least one subject area for the individual, the prescription plan for at least one subject area responsive to the Alpha score in the at least one subject area.

The typical subject areas for a high school equivalency test, such as the commonly known GED® Test, include Language Arts/Reading, Language Arts/Writing, Math, Science and Social Studies. Completion of the initial skills assessment provides a raw score in at least one subject area. The raw score may be determined by determining the number of correct answers in a plurality of questions for at least one of the subject areas or by assessing written portions of the skills assessment according to the same criteria or the same scoring system employed for the subject high school equivalency test, e.g. the GED® Tests. The skills assessment may comprise, for example, whole or partial high school equivalency tests, e.g. sample GED® Tests, which are readily commercially available and known in the art.

In accordance with another aspect of the present invention, there is provided a system for individualizing student preparation for a high school equivalency test. The system comprises a processor and memory comprising computer-readable instructions that, when executed by the processor, cause a computer to perform the steps of: (a) on a display device, displaying to a user a plurality of questions to which a response is requested for at least one subject area of a high school equivalency test; (b) determining a number of questions answered correctly by the user, wherein a number of correctly answered questions of the plurality of questions comprises a raw score; and (c) determining an Alpha score for at least one subject area, wherein the Alpha score is a difference between a passing score for the high school equivalency test in at least one subject area and the raw score in the at least one subject area.

In yet another embodiment, there is provided a computer readable medium storing computer readable instructions that, when executed by a processor, cause a computer to perform the steps of: (a) on a display device, displaying to a user a plurality of questions to which a response is requested for at least one subject area of a high school equivalency test; (b) determining a number of questions answered correctly by the user, wherein a number of correctly answered questions of the plurality of questions comprises a raw score; and (c) determining an alpha score for the at least one subject area, wherein the alpha score is a difference between a passing score for the high school equivalency test in the at least one subject area and the raw score in the at least one subject area.

### BRIEF DESCRIPTION OF THE DRAWINGS

The present invention can be more easily understood and the advantages and uses thereof more readily apparent when the following detailed description of the present invention is read in conjunction with the figures wherein:

FIG. 1 illustrates a format for presenting a student's GED® initial and midterm assessments (scores) according to the teachings of the present invention.

FIGS. 2-10 illustrate the tested content areas and tested thinking skills for each of the five subject areas of the GED® Test.

FIGS. 11-16 illustrate the student's Alpha scores in histogram form for the GED® Test areas.

FIG. 17 illustrates an exemplary student study schedule.

FIG. 18 illustrates an exemplary Academic Resource Guide (ARG) for the Language Arts/Writing section of the GED® Tests.

FIGS. 19A and 19B illustrate an academic content outline for Language Arts/Writing section of the GED® Test.

FIGS. 20A-20D illustrate excerpts from a 21-day Language Arts/Writing lesson plan.

FIG. 21 illustrates a 12-day Math lesson plan outline for students/soldiers with an ASVAB score over 55.

FIGS. 22A and 22B illustrate a 16-day Math lesson plan outline for students/soldiers with an ASVAB score with the range of 40-54.

FIGS. 23A-23C illustrate a 16-day lesson plan for Science, Social Studies and Reading.

FIG. 24 illustrates a schematic of a method according to one aspect of the present invention.

### DETAILED DESCRIPTION OF THE INVENTION

Before describing in detail the exemplary methods related to preparation for a high school equivalency test, e.g. the GED® Test, it should be observed that the present invention resides primarily in a novel and non-obvious combination of elements and steps. Hereinafter, the specification makes reference to the GED® Test as it is the currently recognized high school equivalency test in the U.S. However, it is understood that the present invention is not limited to the GED® Test. So as not to obscure the disclosure with details that will be readily apparent to those skilled in the art, certain conventional elements and steps have been presented with lesser detail, while the drawings and the specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

In particular embodiments, the present invention blends a unique mixture of strength and deficiency assessments, analyses, prescriptions, training materials, teaching techniques, staffing patterns, motivation, and quality control to achieve maximum success with students in a highly compressed time period. It is these tools and the manner in which they are used that form the backbone of the present invention's product and process. Since its inception, 83% of the students who followed the methods of the present invention passed the GED® Tests, whereas only about 62% of students outside the program of the present invention passed. Further, the program of the present invention spans 10-21 days, a fraction of the time of other prior programs of study.

In an embodiment, the present invention comprises a targeted classroom curriculum and initial, ongoing and individual student assessments that break down the five areas of the GED® Test into achievable and believable benchmarks.

### Component 1: Student Assessment

Upon enrollment in the GED PLUS® Program of the present invention, each student completes a partial or full assessment of her/his skills in any one or more of the five subject areas of the GED® Tests: Language Arts/Reading, Language Arts/Writing, Math, Science and Social Studies. As described herein, the Language Arts/Writing section of the examination may be referred to as Essay and/or Editing, as these tend to be subcategories within the Language Arts/Writing section. Each student may also completes a learning styles inventory that identifies his/her preferred learning style. This initial assessment facilitates practice for the actual GED® Tests while also prescribing areas of student academic training.

Throughout the program, instructors work closely with students (a student/teacher ratio of 10/1 is desired) to identify student strengths and build skills through a measured approach that emphasizes individual learning and assessment.

The results of the initial assessment information are collected in a GED® GEDA/CPP (General Education Development Analysis/Comprehensive Prescription Plan (hereinafter “GEDA/CPP” or “comprehensive prescription plan”)—developed and copyrighted by Paxen, with whom the inventors are affiliated. The GEDA/CPP may provide an individual breakdown of the content area and thinking skills in each of the five tested sections, helping to unlock the key to efficient and focused study. Thus, the GEDA/CPP is a multi-purpose document that also provides a convenient place-holder for information the student will require for the preparation program, including the student's prior GED® Test scores and the student's scores on the learning styles inventory. The results of a student's initial assessment are reported in tabular form as shown in FIG. 1.

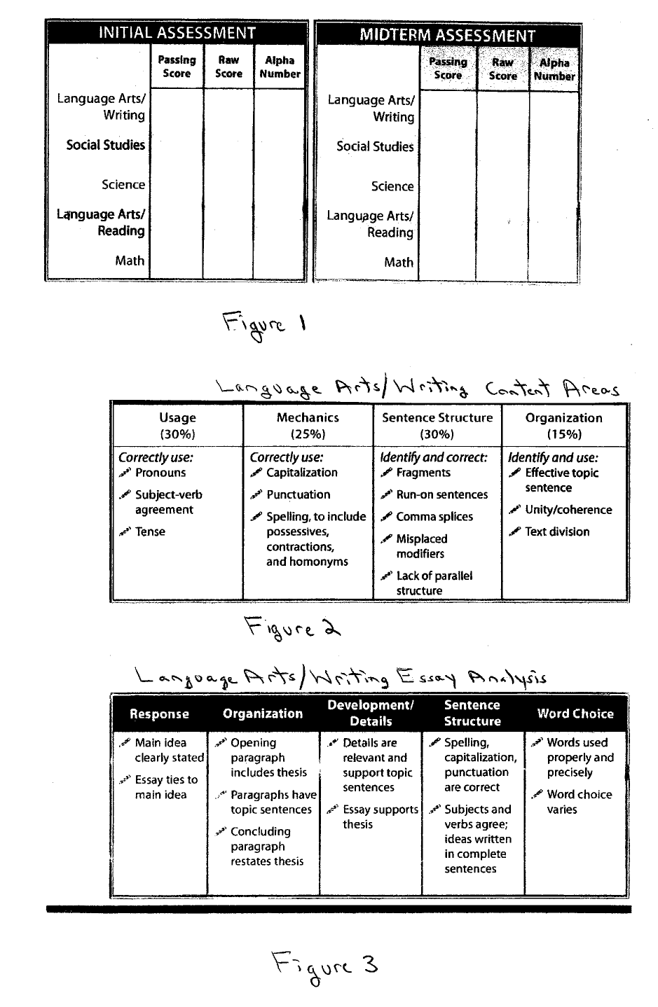

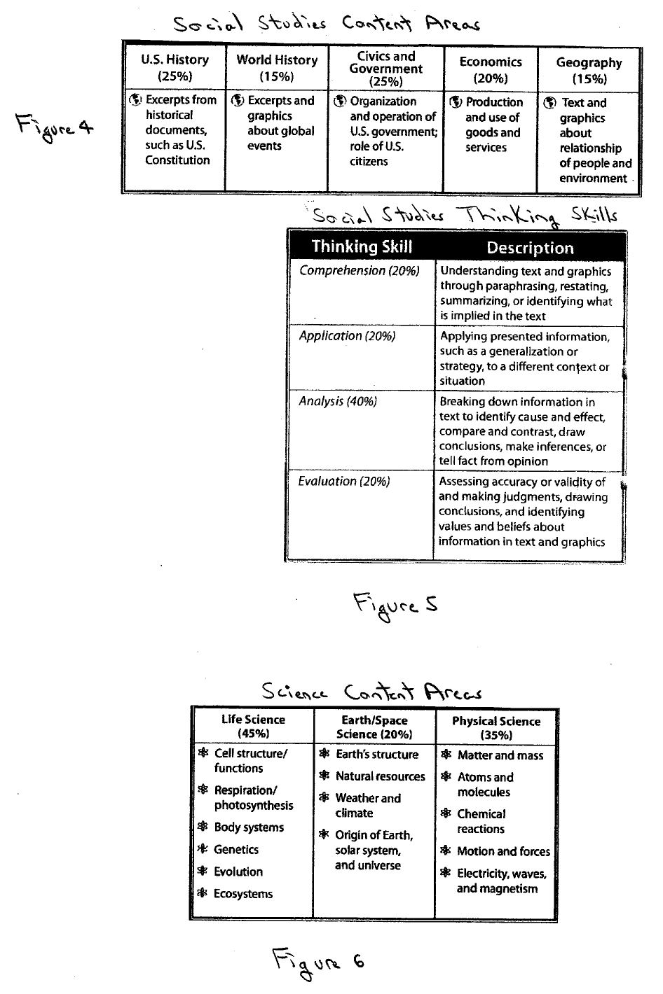

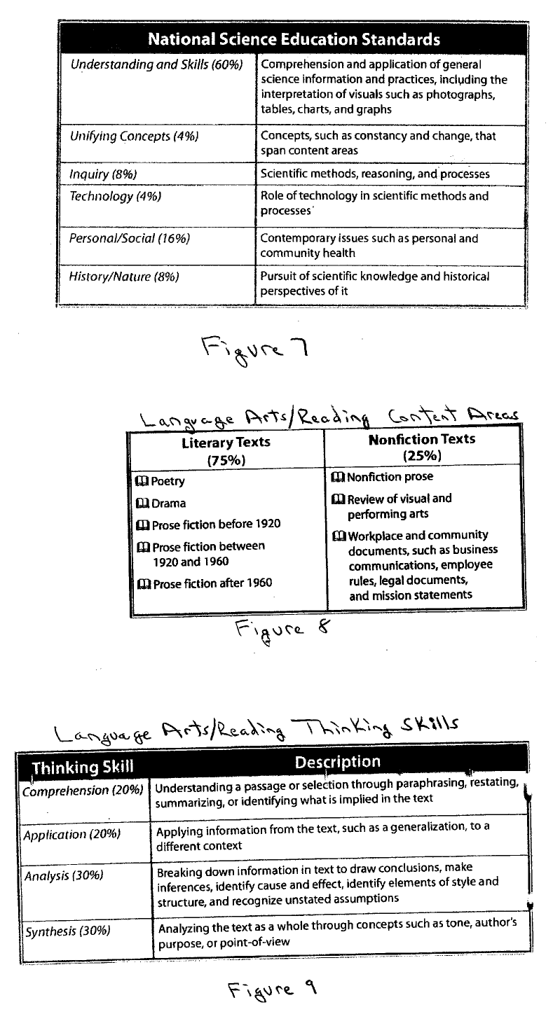

The GEDA/CPP also describes the GED® Test generally and each of the five test areas in detail. FIG. 2 illustrates content areas of Part I of the Language Arts/Writing portion of the examination. Part II of the Language Arts/Writing portion of the test requires the student to write an essay on a topic of general knowledge. FIG. 3 illustrates the main content areas of the student's essay that will be analyzed.

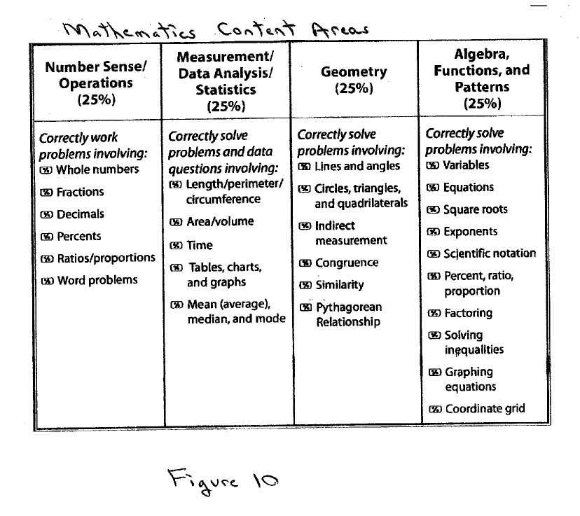

The content areas (and percentage of each area) and the thinking skills of the Social Studies portion of the examination are described in FIGS. 4 and 5. The content areas (and the percentage of each area) of the Science portion of the examination are set forth in FIG. 6. Items in the Science content areas reflect the Science education standards set forth in FIG. 7. The thinking skills involved with the Science portion of the examination are the same as those set forth in FIG. 5 for the Social Studies portion of the examination.

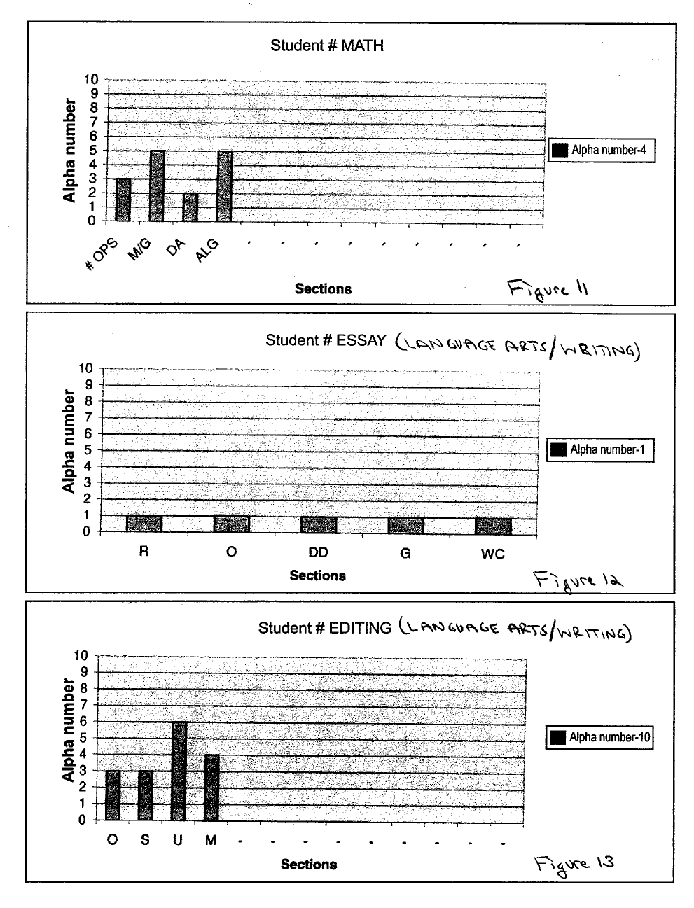

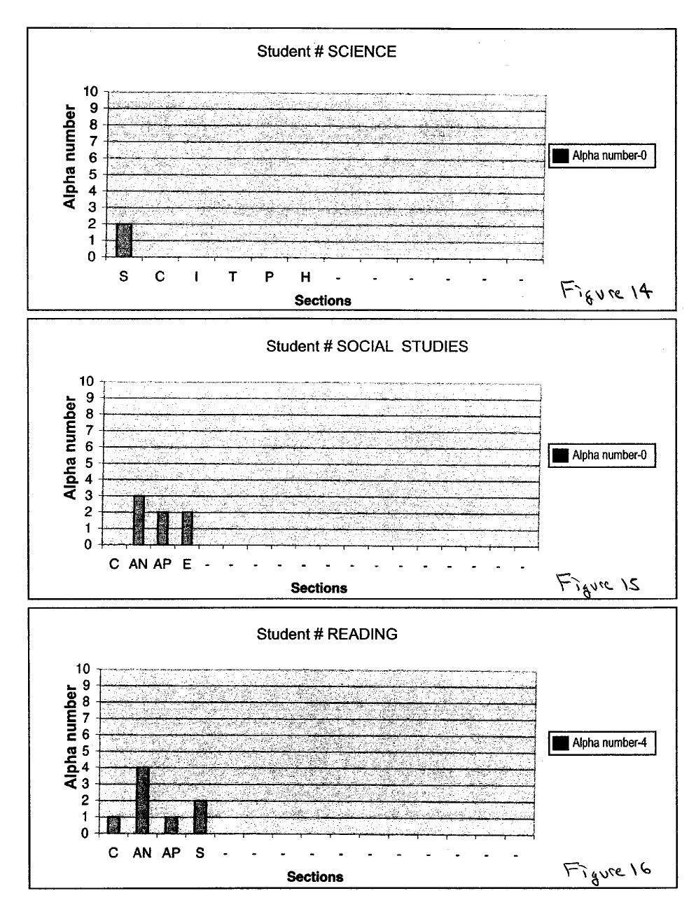

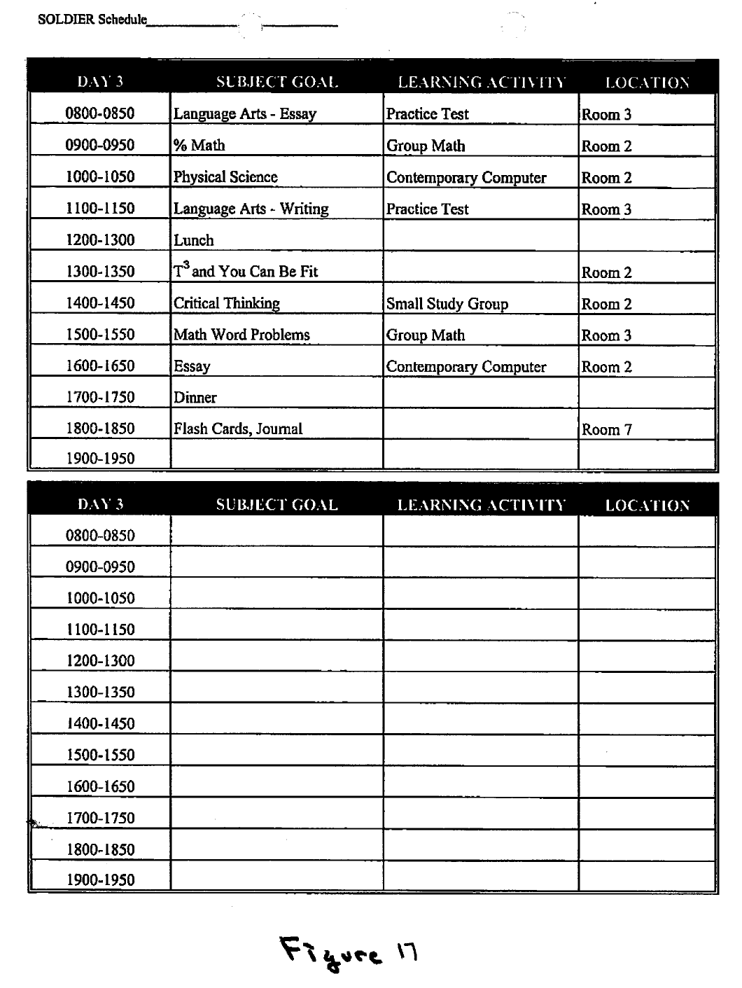

FIGS. 8 and 9 set forth the content areas and the thinking skills, respectively, for the Language Arts/Reading portion of the examination. FIG. 10 sets forth the contents areas for the Mathematics portion of the examination.

The comprehensive prescription plan is a customized and comprehensive plan for success on the GED® test. Based on the student's initial (and midterm) test results and in cooperation with the instructional staff, the comprehensive prescription plan outlines areas of improvement for each of the five GED® subject areas. These areas include thinking skills along with content areas and related subcategories. An assortment of the nation's top GED® publications enable instructors to select those materials that best suit each student. Thus, the prescription plan is tailored to each student's abilities, needs and past achievements.

In addition to the initial assessment, each student is given a midterm assessment to determine progress since the beginning of the program and areas of strengths and weakness. The initial and midterm assessments are about half the length of the actual GED® examination and reflect the overall composition and tone of the GED® examination.

As part of the prescription plan, a student's Alpha scores—the additional number of questions the student must answer correctly to pass the GED® test, or the difference between a passing score and the student's raw score—are determined from both the initial assessment and the midterm assessment. Daily and personal teacher/student interaction also permits the teacher to develop an understanding of the student's strengths and weaknesses. The Alpha score allows the student to numerically track, at a test section or subtest section level, the content areas and thinking skills that are presenting the most difficulty for the student. The instructor, the student and a Training Analyst (discussed below) collaborate to craft a strategy to overcome these difficulties and improve the likelihood of a successful outcome.

In one embodiment of the present invention, the Alpha scores are determined by administering a computer-based GED-like test to each student. The computer determines the number of correct and incorrect answers and calculates the student's Alpha score. The Alpha score is then made available to the instructor and the student, generally in the form of a written report or as a number, histogram or graph on a computer display screen. By focusing on the number of additional questions that the student must answer correctly to pass the GED® Test, the student's focus and confidence is increased. Generally, this number of additional correct questions is relatively small (for example, two or three) and thus builds the student's confidence that success can be achieved. It has been determined that focusing on the Alpha score is an important contributor to success in passing the GED® Test. In an embodiment, the Alpha score may also be calculated for subcategories within each test subject.

Thus, the GEDA/CPP report organizes relevant test and study information so that a student's deficiencies are emphasized, allowing a coach/instructor to address and help correct them. The GEDA/CPP report, based on the initial and midterm assessments and also the Alpha numbers in each subject area, also provides priority indications of subject-matter areas in which the student may be deficient and daily schedules or lesson plans for exercises in these subject areas.

### Component 2: Analysis

A Training Analyst, generally, not a person conducting the day-to-day teaching but instead a person who oversees the instructional process, reviews and evaluates each student's assessment results, determines the Alpha scores for each examination section and guides the instructional curriculum to overcome the student's deficiencies. Such efforts help direct the daily work of the teacher and the student to maximize classroom and learning efficiency. The Alpha score is considered a unique program characteristic that facilitates focus on an individual's learning needs in each functional area. The Alpha score for Math, for example, is the difference between the number needed to pass (generally, 16 or 17 out of 25 questions), and the number correctly completed by the student. This Alpha characterization allows the student and Training Analyst to quantify the task in a daily, measurable, and achievable way.

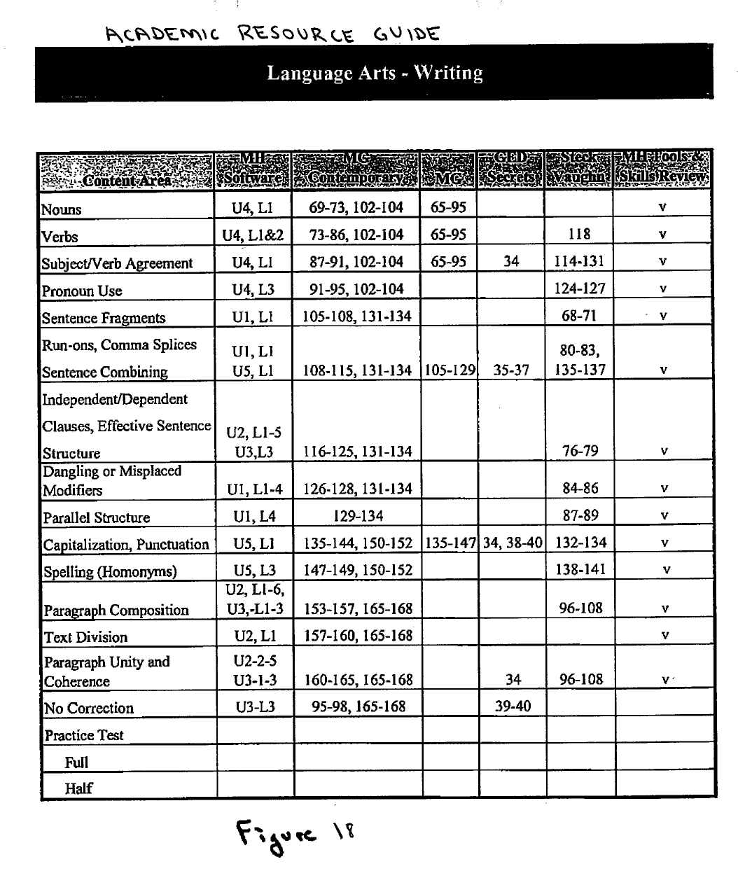

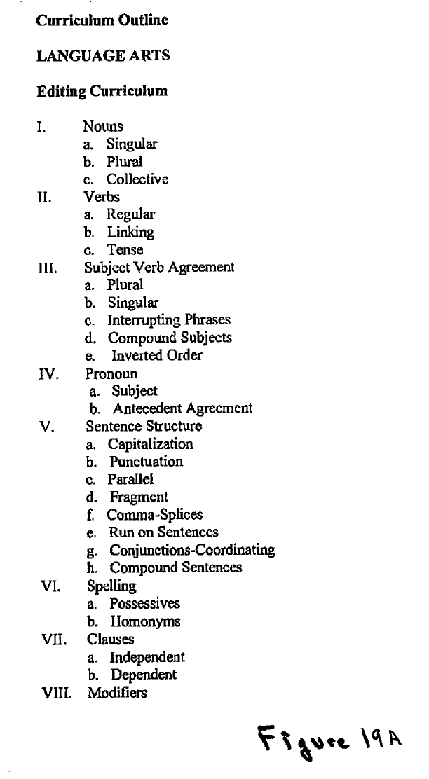

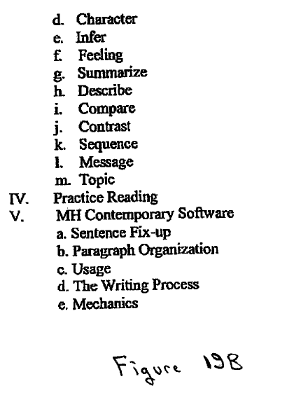

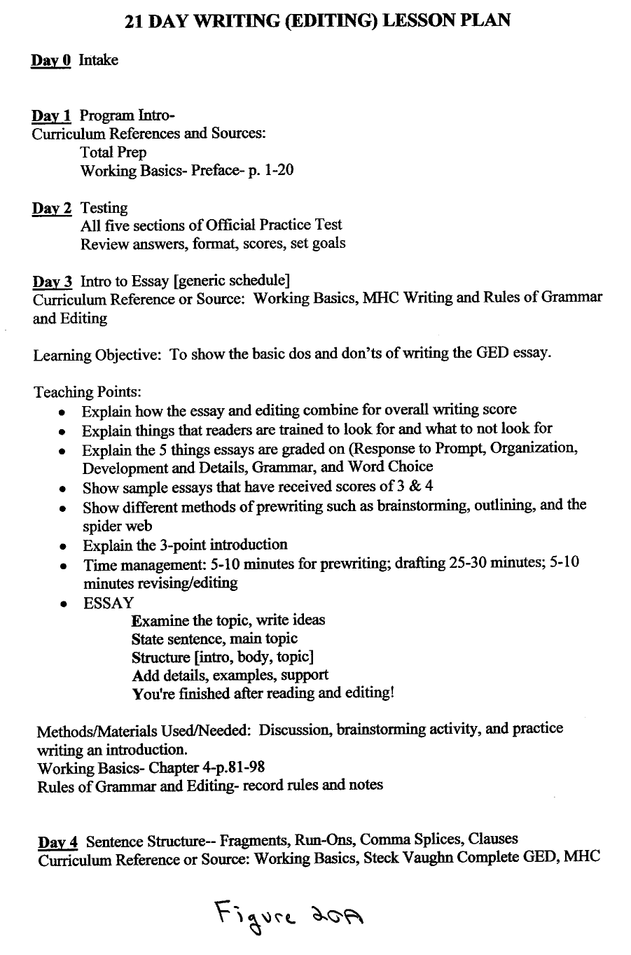

In one embodiment, the student's Alpha score in each subject area (Language Arts/Writing, Language Arts/Reading, Math, Science and Social Studies) and the student's raw score in the subject are presented in the Comprehensive Prescription Plan in the form of histograms of FIGS. 11-16. The Language Arts/Writing section is segregated into the Editing and Essay subcategories, and the two scores are combined to yield the Language Arts/Writing score for the GED® Test.

The box to the right of each histogram indicates the Alpha score for that subject area. Using the Alpha score for each test subject area, histograms for each sub-area within the subject area are determined. The goal in assigning Alpha scores to each sub-area is to ensure the student focuses appropriate attention on that sub-area. There is no predetermined numerical relationship between the Alpha score for each sub-area and the Alpha score for the subject area. However, the sub-area Alpha scores are determined with the objective of building in a passing buffer and encouraging the student's focus on sub-areas that are known to be regularly tested. Thus, as illustrated, the x-axis for each subject histogram breaks out the Alpha numbers for each sub-area. This feature provides the student with a more granular view of his/her performance and a more specific topic for further study.

The mission and tasks suggested to increase the student's score are derived from the Comprehensive Prescription Plan graphs of FIGS. 11-16. The histograms are produced by the Analyst (the graphs were developed and copyrighted by Paxen). The alpha scores are also numerically set forth in tabular form for the initial and midterm assessments of FIG. 1.

To pass the GED® Test, the student needs an average score of 450 for all sections of the examination and a score of at least 410 in each subject area. All scores are equally weighted in determining the average for the entire examination. To put this in concrete, achievable terms, the present invention uses the Alpha score to remove the intimidation factor and boost the student's confidence. For example, if a student scores 15 correct answers and needs 17 correct answers to pass, the student's Alpha score is 2. It is then explained to the student that he/she needs to learn two new concepts during the class to pass that section of the GED® Test. That is an achievable, concrete goal to someone, who has not succeeded academically.

With respect to the Language Arts/Writing test section, generally, a higher score on the Essay subsection of this section allows the student to miss more questions on the multiple-choice, Editing subsection. Conversely, a lower score on the Essay subsection requires more correct answers on the Editing subsection.

Student study schedules vary hourly and daily according to goals and individual learning activities to attain those goals. This hourly and daily variation presents a unique feature of this system. Student learning needs drive the individual student's schedules, not the needs of a teacher or a bureaucracy. This is a critical distinction from traditional adult classroom instruction and test-preparation courses.

The Training Analyst identifies what a student must learn for the test from the initial practice test on Day One and schedules a block or blocks of time for instruction to occur. Usually, several students share the same deficiencies so a class block is formed of those students. Students who need to learn adding fractions study the addition of fractions until they can perform the skill. The same study processes are employed for other test areas.

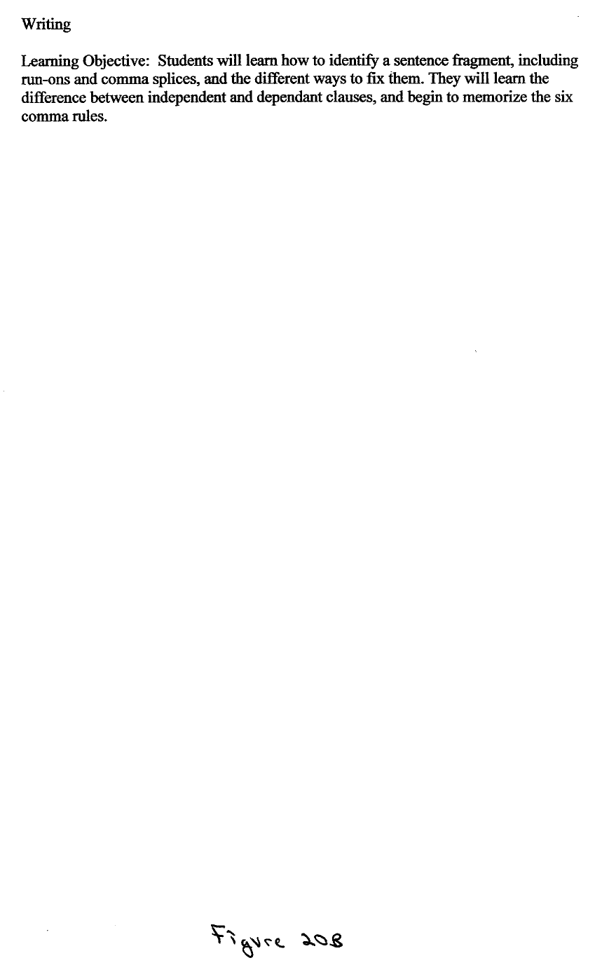

FIG. 17 illustrates an exemplary student study schedule, indicating a plurality of 50-minute time periods for Study Day 3, a subject goal for each 50-minute period, a specific learning activity for that subject goal and a location for the learning activity. Typically, each student's study schedule is altered as the student's needs change. Those changing needs are determined by continuing testing (the midterm examination, for example) and the teacher's opinion based on daily interaction with the student.

One learning styles inventory test for ranking each student's learning styles is available from Memletics at www.memletics.com. Other learning styles inventory tests are known to those skilled in the art. Generally, the common learning styles include: visual, aural, verbal, physical, logical, social and solitary. The inventory test presents a plurality of situations and the student is asked to indicate the extent to which the presented situation reflects the student's personality. The answers are scored to reveal the extent to which the student favors each of the learning styles.

It has been found that a very large percentage of GED® test takers prefer a social study/learning environment. However, no matter the student's preferred learning style, the results of the learning styles inventory test will indicate each student's preferred learning style. The Comprehensive Prescription Plan is developed to present exercises and opportunities that favor the student's learning style, thereby improving the probability of a successful outcome on the GED® Test.

### Component 3: Prescription

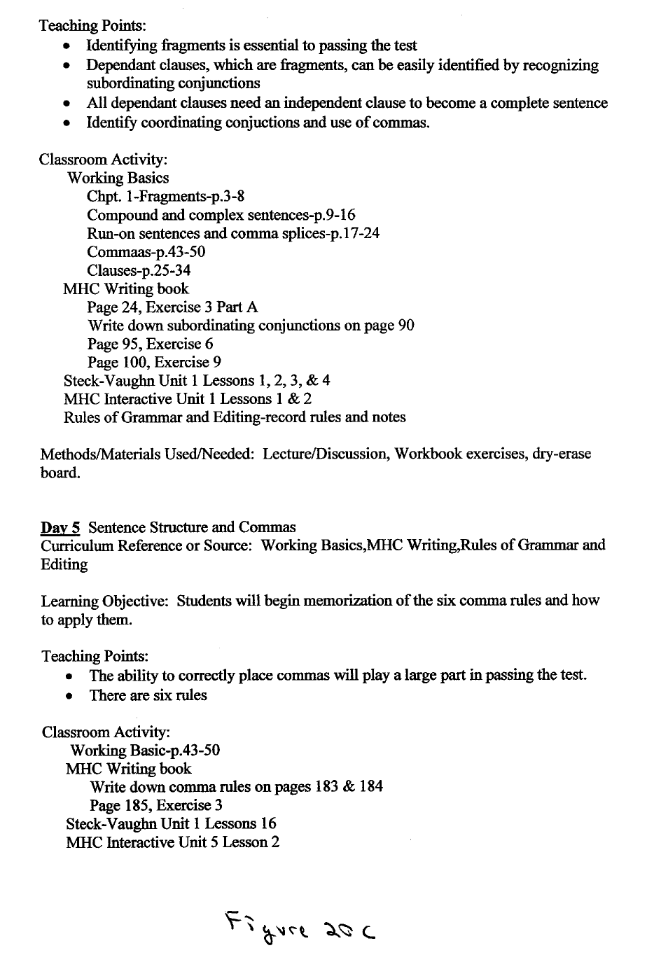

The Analyst creates the Comprehensive Prescription Plan and graphs described above to specifically chart a student's plan of action through directed study for passing the GED® Tests. Analysts and instructors use the available Academic Resource Guide (ARG); see an exemplary Guide of FIG. 18) to select appropriate teaching tools for students' learning styles and to establish an initial daily schedule.

FIG. 18 is an exemplary ARG for the Language Arts/Writing section of the GED® Tests. The ARG is presented in the form of a matrix. The content areas of the Language Arts/Writing section are set forth in matrix rows and resources that the student and teacher may use to improve his/her skills in the tested areas (and consequently improve his/her GED® Tests scores) are set forth in the matrix columns. Each resource is indicated at the heading of the column and a specific location within the resource material related to the content area is indicated at the intersection of the resource column and the content area row. In presenting the material to the students and aiding them in the learning process, the instructor gives due regard to each student's preferred learning style.

Similar ARG's are created for the other tested subjects, each including a plurality of subject-related content areas and resource materials.

### Component 4: Learning Materials

Once the assessment, analysis and prescription plan are completed, the teaching and learning process continues using a full range of academic materials, software and tools designed to aid student success. Certain of these materials, which have been developed by The Paxen Group, Inc. and for which The Paxen Group, Inc. holds the copyright, are described below. These resources, as well as others in the ARG's, are set forth in the column headings of FIG. 18 for the various GED® Tests content areas and are referenced in the Lesson Plans. Specific sections of the each resource are identified to allow the student to focus on particular areas of difficulty. Further resources are available to the student to aid in test preparation.

Rules of Grammar and Editing—This publication is a concentrated workbook and log for students to use in recording and learning key concepts used on the Language Arts/Writing section of the GED®.

Total Prep—The objective of Total Prep is to provide information that will help the GED® test-taker prepare both mentally and physically for optimum performance on the test. The students will: 1) participate in journaling activities that will mentally prepare them for the GED® Tests, as well as provide a practice opportunity for the Language Arts/Writing Test; 2) participate in other cognitive preparation activities, such as goal-setting, visualization and concentration; 3) understand the causal relationship between sound nutrition and heightened learning; and 4) understand the directions on the GED® Tests and the benefits of following them. Specific test-taking tips will aid student success on the GED® Tests.

Work Planner—The attainment of a GED® will represent a major change in students' lives, opening new opportunities for education and employment. Paxen's Work Planner is designed to help participants map and plan for such life changes. Thus, they are trained to fulfill their full potential and enhance their self-esteem through a step-by-step plan for education and employment. Work Planner provides employability skills instruction including: Effective Employee Image, Understanding Managers, Effective Communication, Marketing Yourself, and Time and Stress Management. Work Planner also includes all the tools needed for a successful job search: Career Assessment and Exploration, Lead Sourcing, Networking, Applications, Resumes, Interviewing and Follow-up.

Working Basics for the GED®—Organized and developed around the five functional areas of the GED® Tests; this book provides a proven, skill-based approach that builds new skills and amplifies student strengths critical to academic success. With customized content and activities, the comprehensive Working Basics for the GED® equips students with attainable and measurable benchmarks that facilitate success on the GED® Test.

Skills & Drills for the GED®—By cementing and reinforcing concepts and ideas through a practice-based approach, this workbook offers comprehensive practice modeled after the GED® Tests. Multiple-choice, fill-in, short-answer, and essay questions in Skills & Drills provide students with opportunities to assess their understanding of areas such as Language Arts/Reading, Language Arts/Writing, Math, Science, and Social Studies, while simultaneously gaining familiarity with the style and structure of the GED® Tests. A companion teacher's guide enables instructors to further assess student understanding and target areas of improvement.

You Can Be Fit—This publication introduces people to healthy lifestyles that facilitate mental fitness and optimize test performance. The material guides students to make healthy diet and exercise choices that, in turn, positively influence their academic achievement.

### Component 5: Learning Activities

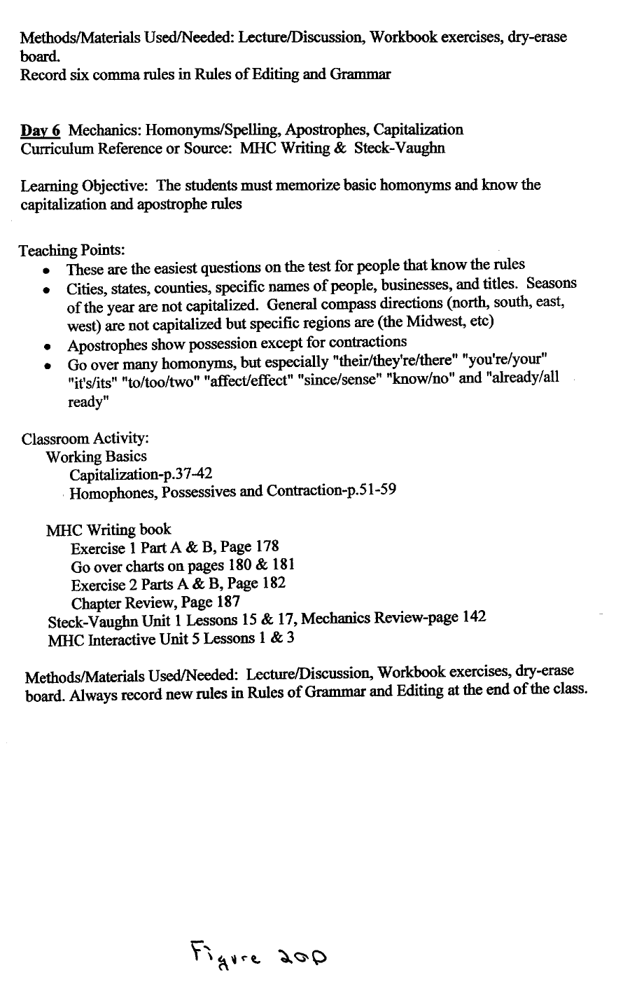

Detailed schedules are developed that draw heavily upon individual and class learning needs. Teachers use various resources, many of them developed by The Paxen Group, Inc., to teach the necessary skills. In addition to the GEDA/CPP and the Academic Resource Guides, instructors and students utilize the Academic Content Outlines (See FIGS. 19A and 19B for the Language Arts/Writing guide; other sections of the examination have similar content outline guides), instructor lesson plans (to be discussed below) and Official Practice Tests of the American Council on Education, distributed by the Steck-Vaughn Company.

Academic content outlines (such as the exemplary academic content outline for Language Arts/Writing in FIGS. 19A and 19B) include detailed lists of the curriculum associated with each of the GED®-Tests areas.

Corresponding instructor lesson plans have been developed for each of the five GED®-Test subject areas. According to one embodiment, lesson plans are available for 12-, 16- and 21-day study periods. One lesson plan is selected depending on the skill level of the entering student. In a military application of the invention, entry skills are measured by scores on the Armed Services Vocational Aptitude Test Battery (ASVAB) that is taken by all recruits as a screening, counseling and qualifying tool. Recruits with a 31-44 ASVAB score generally attend the 21-day session, while soldiers with a score above 55 on the ASVAB require only 12 days of training. As is obvious, people with lower scores need additional time to acquire the skills needed to pass the GED® Test.

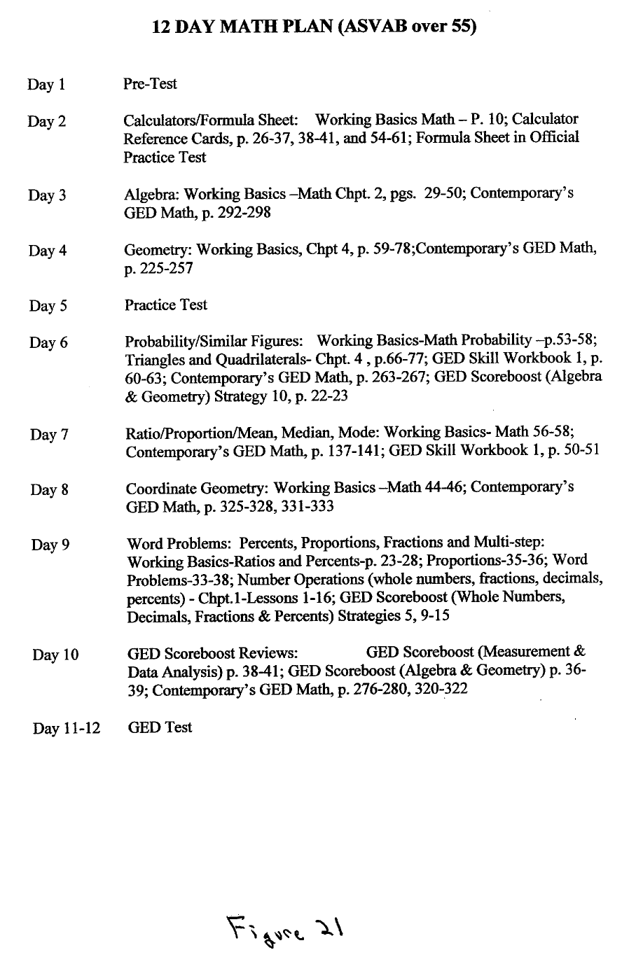

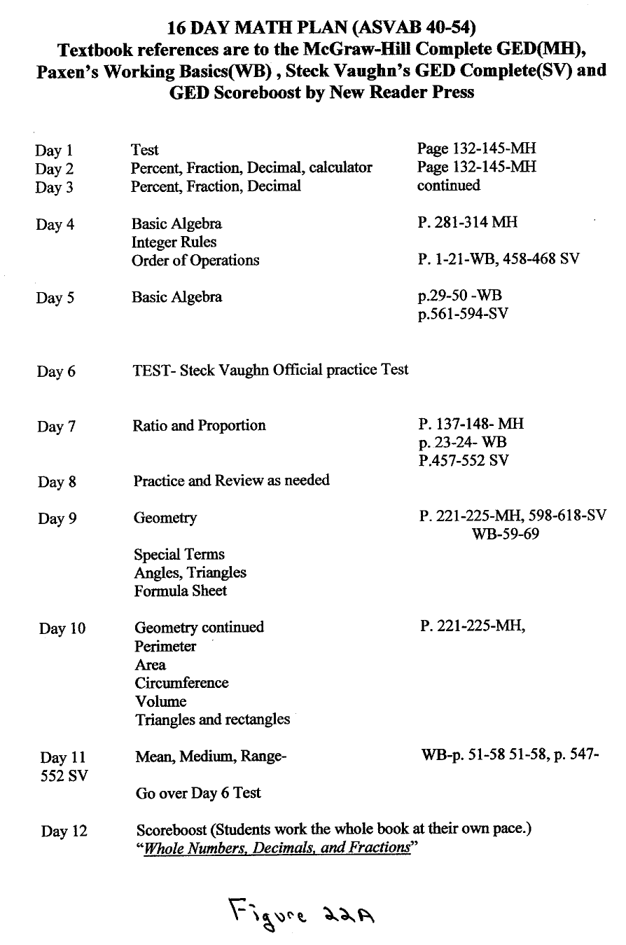

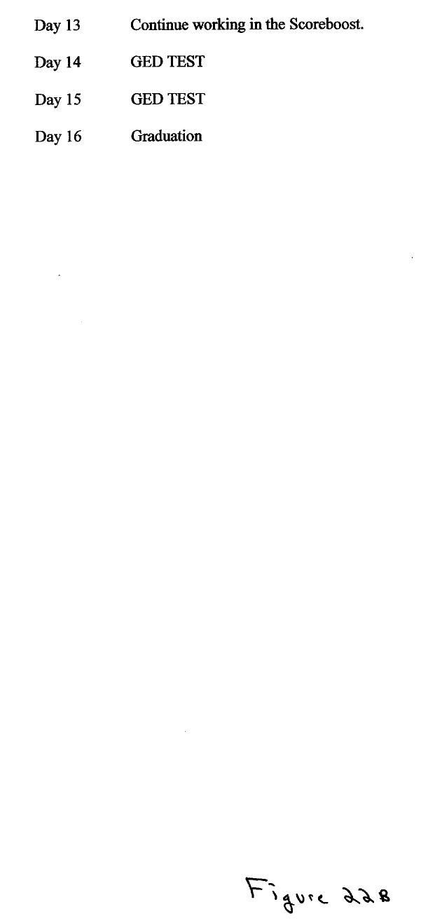

FIGS. 20A-20D illustrate an excerpt from an exemplary 21-day lesson plan for the Language Arts/Writing subject area. Each daily plan includes the material to be covered, a curriculum reference or source, a learning objective, teaching points and methods/materials used/needed. The material covered in the Language Arts/Writing lesson plan illustrates for students the basics of essay writing and the editing of written material on the multiple-choice, Language Arts/Writing section of the GED® Test. Generally, all fixed duration lesson plans for each subject area will be similar in scope and content, but each also takes into account the strengths and deficiencies of each student to ensure that instruction time is focused on areas requiring improvements to pass the GED® Test.

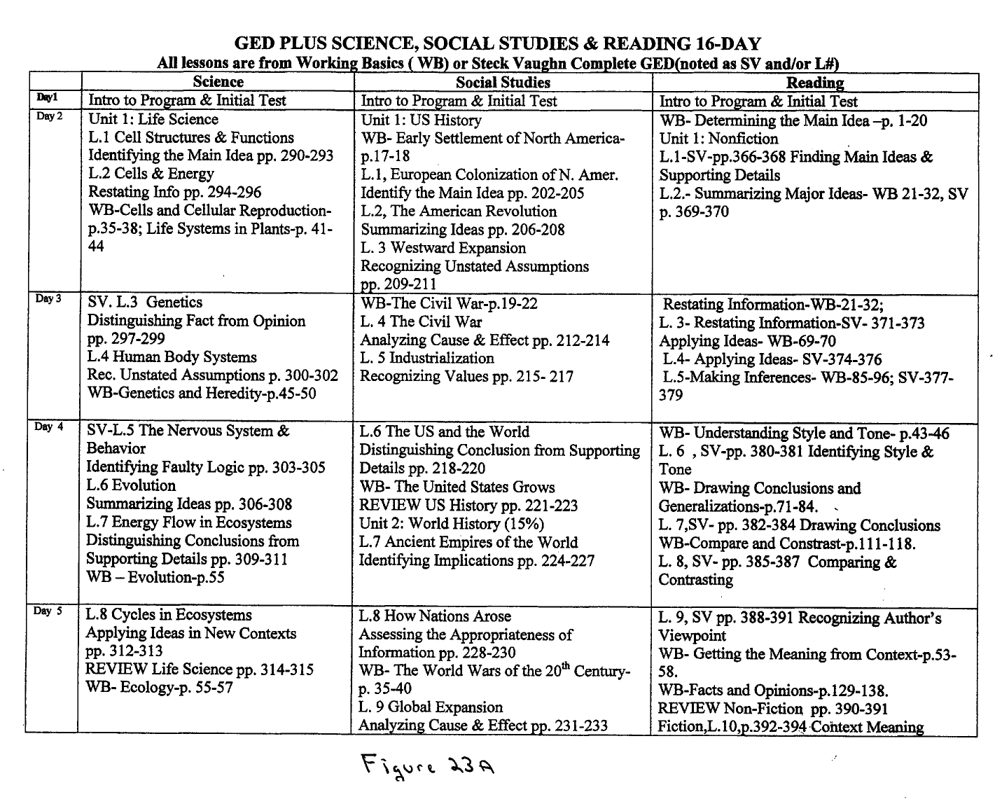

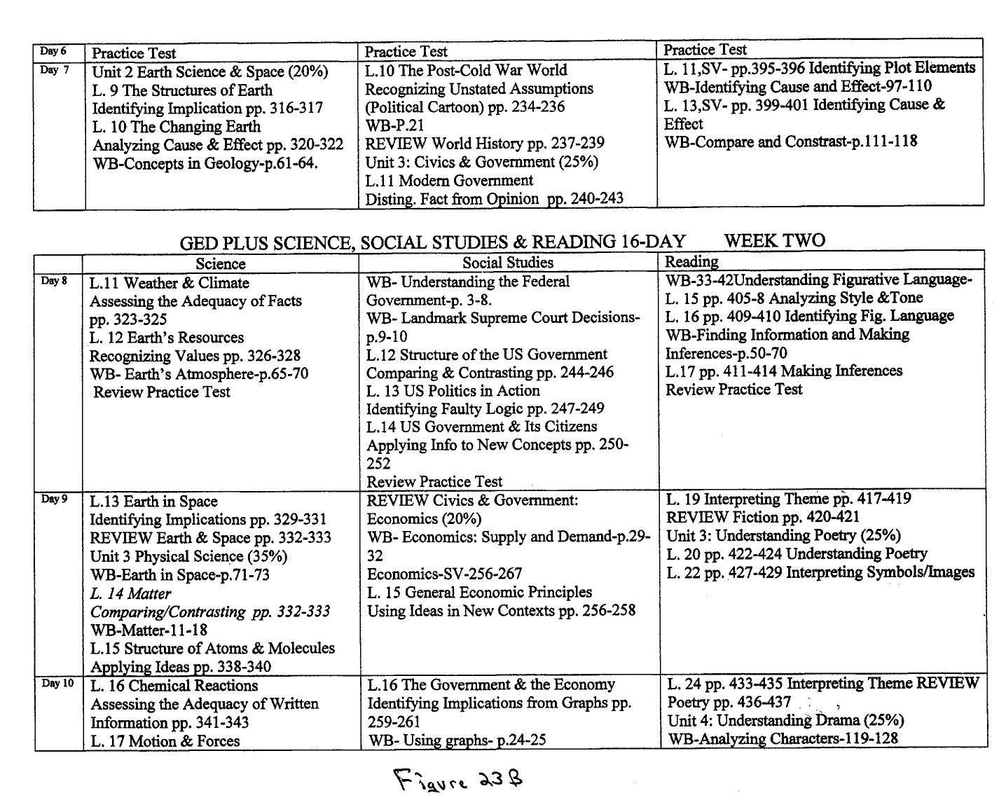

FIGS. 21 and 22A-22B illustrate, respectively, a 12-day Math lesson plan outline for students scoring above 55 on the ASVAB and a 16-day Math lesson plan outline for students scoring 40-55 on the ASVAB. These lesson plan outlines guide the instructional activities as appropriate.

The references to ASVAB test scores in conjunction with FIGS. 21 and 22A-22B apply to an embodiment of the invention for military applicants of the GED Plus®. However, similar lesson plans and class structures can be based on Official Practice Test (available from Steck Vaughn of Orlando, Fla.) results and TABE© (Test of Adult Basic Education; available from McGraw-Hill of New York City, N.Y.) scores.

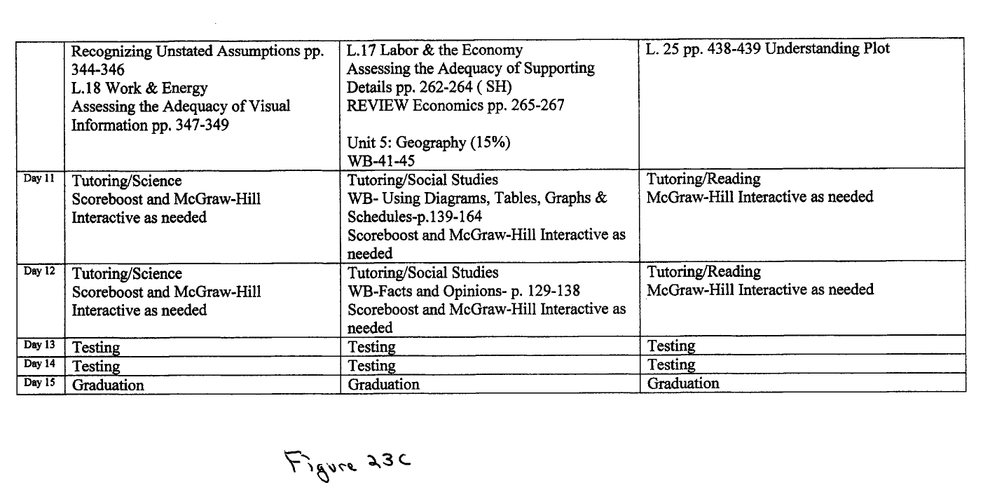

FIGS. 23A-23C illustrate a 16-day Science, Social Studies and Reading lesson plan. Generally, the longer duration lesson plans cover more substantive areas within each tested subject, allowing more time for instruction and practice and additional feedback opportunities. As is known, repetition of any material is one key to its retention.

### Component 6: Unique Role of Staff

The desired student-to-teacher ratio is 10:1, with one Program Manager and Training Analyst for each group of 40 students. This provides administrative staff with sufficient time to closely monitor students' academic progress and to coordinate with instructional staff so that they may teach students the necessary skills. Through this approach, students readily understand and receive instruction toward areas of improvement.

### Component 7: Further Testing Analysis and Motivation

At the midpoint of the course, students again take practice GED® Tests to measure their progress, increase familiarity with the testing format, and direct the final days of training to areas in which they require additional support. Motivation and focus again is maintained by feedback directly related to the task at hand, i.e., the GED® Test questions as presented on the Official Practice Tests.

### Component 8: Actual Test

Staff members coordinate with the appropriate test administration site to register students and to ensure that students arrive at the site when scheduled. This may include resolving such issues as dependent care and transportation to the testing site.

### Component 9: Quality Control

Staff members are constantly monitored and evaluated based on student performance and outcomes, including a Student Satisfaction Survey, classroom performance, attention to administrative details and, most significantly, student success rate on the GED® Tests.

The present invention comprises a unique system of assessment, training, and managing of students for passing the GED® Tests. It includes specialized academic content, homework exercises, test-taking exercises, motivational exercises (including regular discussions of motivational techniques, persuading the student that the goal of passing is realizable as reflected by the low number Alpha score), physical fitness (daily physical training exercises and walking, including teaching students the value of exercise, especially while preparing for an examination such as the GED®), detailed and focused assessment tools and a multi-level management system. This system is adapted and prescribed based on the needs of the individual learner, not on the needs of an educational system, and fully recognizes the short-term focus of the program. The program is designed to be an intense eight hours per day immersion in the subject matter. Repetition of known topics is limited, allowing the student to focus on the material that has not been adequately learned. The present program is concentrated in time with a near-term end.

In contrast, traditional adult education courses run from September to December and January through May, a duration that causes most GED® students to lose focus. Since most GED® students have a short-term focus and need a nearly immediate success to boost their confidence, the intensity and limited duration of the present program better suits the students' needs. Also, the number of instructional hours in the present program exceeds the total number of hours in the traditional four-month adult education program.

The program thus meets the needs of many of today's learners. The system produces results that far exceed national student retention and success rates, doing so in a highly compressed timeframe through expert and dynamic staffing, focused learning, teaching and test-taking techniques, and materials. The compressed timeframe in which this training is delivered enhances its attraction to adults, particularly young ones, thus facilitating a much higher persistence and pass rate on the GED® Tests.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard disks, or any other computer-readable storage medium, wherein, when the computer program code is loaded into and executed by a computer or processor, the computer or processor becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer or processor, the computer or processor becomes an apparatus for practicing the invention. When implemented on a general-purpose computer, the computer program code segments configure the computer to create specific logic circuits or processing modules.

The GED trademark and the GED design trademarks are trademarks of the American Council on Education and are used herein with permission.

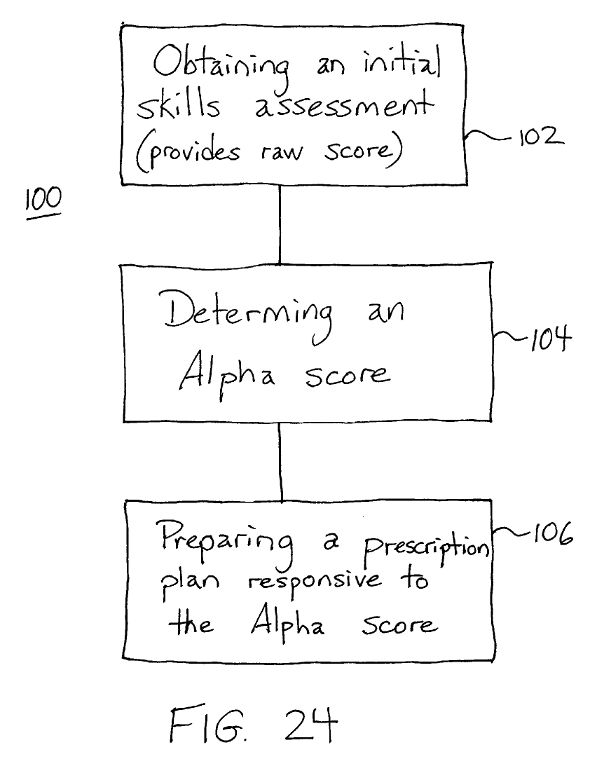

FIG. 24 depicts an embodiment of a method for preparing an individual for a high school equivalency test in accordance with the present invention. The method 100 comprises step 102 of obtaining from the individual an initial skills assessment in at least one subject area of the high school equivalency test, wherein the initial skills assessment provides a raw score in at least one of the GED® Test subject areas. In an embodiment, step 102 may be performed by directing the individual to complete an initial skills assessment in at least one subject area of the high school equivalency test, e.g. a simulated partial or complete GED® Test. Alternatively, the student may have already completed an initial skill assessment, e.g. a partial or complete simulated GED® Test, on their own covering one or more of the subject areas and may provide such scores from the assessment.

The typical subject areas for a high school equivalency test, such as the commonly known GED® Test, include Language Arts/Reading, Language Arts/Writing, Math, Science and Social Studies. Completion of the initial skills assessment provides a raw score in at least one subject area. The raw score may be determined by determining the number of correct answers in a plurality of questions for at least one of the subject areas or by assessing written portions of the skills assessment according to the same criteria or the same scoring system employed for the subject high school equivalency test, e.g. GED® Tests. The skills assessment may comprise, for example, whole or partial high school equivalency tests, e.g. sample GED® Tests, which are readily commercially available and known in the art.

The method 100 further comprises step 104 of determining an Alpha score for the at least one subject area based on the initial skills assessment. The Alpha score is a difference between a passing score for the high school equivalency test in at least one subject area and the raw score for at least one (corresponding) subject area. In addition, the method further comprises step 106 of preparing a comprehensive prescription plan for at least one subject area for the individual. The prescription plan for at least one subject area is responsive to the Alpha score in at least one subject area. In other words, the prescription plan is adapted to provide the user with instruction, practice, and any other learning opportunity in the subject matter(s) or sub-areas thereof in order to provide the individual with the knowledge to reduce their Alpha score and work toward a passing grade on a simulated or actual high school equivalency test. In an embodiment, the comprehensive prescription plan comprises a plurality of subject materials to be studied by the individual during a predefined time period.

In another embodiment, the method further comprises directing the individual to complete a learning styles inventory to identify a preferred learning style for the individual and adapting the written comprehensive prescription program to the preferred learning style of the individual. Accordingly, if the individual learns best, for example, by the visual sense, the written prescription plan will include documents, lessons, and the like, which include visual illustrations. Typically, the different learning styles comprise visual, aural, verbal, physical, logical, social and solitary learning styles.

In yet another embodiment, the duration of the comprehensive prescription plan for the method is dependent on the results of the initial skills assessment. For example, the duration of the comprehensive prescription plan may be 12, 16 or 21 days, or any other suitable time period for providing the individual with the knowledge necessary to pass the GED® Tests.

In yet another embodiment, the method further comprises directing the individual to complete a second skills assessment (subsequent to the initial skills assessment) in at least one of the subject areas of the high school equivalency test subsequent. This may be, for example, at a midterm of a preparation course as described herein. From the second skills assessment, the method may further comprise determining a revised Alpha score for the relevant subject area based on the second skills assessment. Further, the method may comprise revising the written comprehensive prescription plan for at least one subject area. Thus, the comprehensive plan could be modified to update the individual's progress including further addressing problem areas, as well as identifying new problems areas and eliminating former problem areas where the individual is now testing above passing level for the general equivalency test.

In yet another embodiment, the above method not only applies to any one or more of the subject areas for a high school equivalency test, e.g. GED® Test, but also to sub-areas of each of the subjects. Accordingly, the directing an individual to complete the initial skills assessment may also comprises determining an Alpha score in one or more sub-areas of a subject area of the high school equivalency test. Further, the comprehensive prescription plan may be adapted to be responsive to the Alpha score in at least one sub-area.

The method further comprises performing steps on a plurality of individuals, and selecting a similarly situated group from the plurality of individual members having to study together as a group for any one or more of the high school equivalency subject areas.

Any one or more of the above method steps may also be incorporated into a computer-based system including a processor and a memory comprising computer-readable instructions that, when executed by the processor, cause a computer to perform any one or more of the method steps above.

While the present invention has been described with reference to preferred embodiments, it will be understood by those skilled in the art that various changes may be made and equivalent elements may be substituted for the elements thereof without departing from the scope of the invention. The scope of the present invention further includes any combination of elements from the various described embodiments. In addition, modifications may be made to adapt a particular situation to the teachings of the present invention without departing from its essential scope. Therefore, it is intended that the invention not be limited to the particular embodiments disclosed, but that the invention will include all embodiments falling within the scope of the appended claims.

What is claimed is:

1. A method for preparing an individual for a high school equivalency test comprising:
(a) obtaining from the individual an initial skills assessment in at least one subject area of the high school equivalency test, wherein the initial skills assessment provides a raw score in the at least one subject area; and
(b) determining an Alpha score for the at least one subject area based on the initial skills assessment, wherein the Alpha score is a difference between a passing score for the high school equivalency test in the at least one subject area and the raw score in the at least one subject area; and
(c) preparing a comprehensive prescription plan for the at least one subject area for the individual, the prescription plan for the at least one subject area responsive to the Alpha score in the subject area.

2. The method of claim 1, further comprising:
directing the individual to complete a learning styles inventory to identify a preferred learning style for the individual; and
adapting the comprehensive prescription plan to the preferred learning style of the individual.

3. The method of claim 2, wherein the learning styles comprise visual, aural, verbal, physical, logical, social and solitary learning styles.

4. The method of claim 1, wherein a duration of the comprehensive prescription plan is dependent on the results of the initial skills assessment.

5. The method of claim 1, further comprising:
directing the individual to complete a second skills assessment in the at least one subject area subsequent to the initial skills assessment;
determining a revised Alpha score for the at least one subject area based on the second skills assessment; and
revising the comprehensive prescription plan for the at least one subject area, the revised prescription plan for the at least one subject area responsive to the revised Alpha score in the at least one subject area.

6. The method of claim 1, wherein the raw score is provided by determining a number of questions answered correctly in the at least one subject area.

7. The method of claim 1, wherein the at least one subject area comprises each of Language Arts/Reading, Language Arts/Writing, Math, Science and Social Studies.

8. The method of claim 1 wherein a duration of the comprehensive prescription plan is 12, 16 or 21 days.

9. The method of claim 1 wherein the step of obtaining from the individual a initial skills assessment comprises determining strengths and deficiencies in each subject area of the high school equivalency test and in each sub-area of each subject area.

10. The method of claim 1 wherein the comprehensive prescription plan comprises a plurality of subject materials to be studied by the individual during a predefined time period.

11. The method of claim 1, further comprising performing steps (a)-(c) on a plurality of individuals, and directing individuals of the plurality of individuals having similar needs to study together as a group for a particular one of the subject areas.

12. The method of claim 1, wherein the at least one subject area comprises at least one sub-area, and further comprising determining an Alpha score for the at least one sub-area; and preparing the comprehensive prescription plan responsive to the Alpha score in the at least one sub-area.

13. A system for individualized student preparation for a high school equivalency test, comprising:
a processor;
a memory comprising computer-readable instructions that, when executed by the processor, cause a computer to perform the steps of:
(a) on a display device, displaying to a user a plurality of questions to which a response is requested for at least one subject area of a high school equivalency test;
(b) determining a number of questions answered correctly by the user, wherein a number of correctly answered questions of the plurality of questions comprises a raw score; and
(c) determining an Alpha score for the at least one subject area, wherein the Alpha score is a difference between a passing score for the high school equivalency test in the at least one subject area and the raw score in the at least one subject area.

14. The system of claim 13, wherein the computer readable instructions further comprise the step of providing a comprehensive prescription plan for at least one subject area for the individual, the prescription plan for each subject area responsive to the Alpha score.

15. The system of claim 13, wherein the at least one subject area comprises at least one subject area in the group consisting of Language Arts/Reading, Language Arts/Writing, Math, Science and Social Studies.

16. A computer-readable medium storing computer readable instructions that, when executed by a processor, cause a computer to perform the steps of:
(a) on a display device, displaying to a user a plurality of questions to which a response is requested for at least one subject area of a high school equivalency test;
(b) determining a number of questions answered correctly by the user, wherein a number of correctly answered questions of the plurality of questions comprises a raw score; and
(c) determining an Alpha score for the at least one subject area, wherein the Alpha score is a difference between a passing score for the high school equivalency test in the at least one subject area and the raw score in the at least one subject area.

17. The computer-readable medium of claim 16, wherein the computer readable instructions further comprise providing a comprehensive prescription plan for the at least one subject area for the individual, the comprehensive prescription plan for each subject area responsive to the Alpha score.

18. The computer-readable medium of claim 16, wherein at least one subject area comprises at least one subject area in the group consisting of Language Arts/Reading, Language Arts/Writing, Math, Science and Social Studies.
